(19) United States
(12) Patent Application Publication
(10) Pub. No.: US 2010/0308587 A1
(43) Pub. Date: Dec. 9, 2010

(54) MINI-TURBINE DRIVEN BY FLUID POWER FOR ELECTRICITY GENERATION

(76) Inventors: Seng-Da TU, Taipei (TW); Uan-Iu Tu, Taipei (TW)

Correspondence Address: Guice Patents PLLC, 12647 Galveston Court #302, Manassas, VA, 20112, US

(21) Appl. No.: 12/479,790

(22) Filed: Jun. 6, 2009

(51) Int. Cl. H02K 7/18

(52) U.S. Cl. 290/52

(57) ABSTRACT

A mini-turbine includes a hollow inner cylinder adapted to connect to a fluid source; a rotor disposed in and rotatably connected to the inner cylinder, the rotor comprising blades and an enclosed permanent magnet for producing a magnetic field; a winding mounted around the inner cylinder and being about flush with the rotor; a hollow outer cylinder mounted around the inner cylinder in a spaced fashion; and a nozzle disposed at a top opening of the inner cylinder and above the rotor. In one embodiment, pressurized water from a faucet may impinge upon the blades to rotate the rotor after passing the nozzle so that the rotor may cut lines of magnetic flux in the magnetic field to generate an induced AC voltage in the winding.

### BACKGROUND OF THE INVENTION

1. Field of Invention

The invention relates to electricity generation equipment and more particularly to a mini-turbine driven by fluid power (e.g., pressurized liquid or compressed gas) to generate electricity for illumination or low power applications.

2. Description of Related Art

Conventionally, alternators are large, heavy devices and designed for specific applications. However, so far as the inventor is aware, there are no mini-alternators to generate electricity for illumination or low power applications disclosed in any documents or commercially available. Hence, a need has arisen for a mini-turbine.

### SUMMARY OF THE INVENTION

It is therefore one object of the invention to provide a mini-turbine driven by fluid power (e.g., pressurized liquid or compressed gas) to generate electricity for illumination or low power applications.

To achieve the above and other objects, the invention provides a mini-turbine comprising a hollow inner cylinder adapted to connect to a fluid source; a rotor disposed in and rotatably connected to the inner cylinder, the rotor comprising a plurality of blades and an enclosed permanent magnet for producing a magnetic field; a winding mounted around the inner cylinder and being about flush with the rotor; a hollow outer cylinder mounted around the inner cylinder in a spaced fashion; and a nozzle assembly disposed at a top opening of the inner cylinder and extending to a predetermined position above the rotor, wherein pressurized fluid from the fluid source may impinge upon the blades to rotate the rotor after passing the nozzle assembly so that the rotor may cut lines of magnetic flux in the magnetic field to generate an induced AC voltage in the winding.

The above and other objects, features and advantages of the invention will become apparent from the following detailed description taken with the accompanying drawings.

### BRIEF DESCRIPTION OF THE DRAWINGS

FIG. 1 is an exploded view of a first preferred embodiment of mini-turbine according to the invention;

FIG. 2 is a perspective view of the assembled mini-turbine;

FIG. 3 is a broken-away perspective view of the mini-turbine shown in FIG. 2;

FIG. 4 is a longitudinal sectional view of the mini-turbine shown in FIG. 2;

FIG. 5 is another longitudinal sectional view of the mini-turbine shown in FIG. 2 where the rotor has turned about 45 degrees;

FIG. 6 is a view similar to FIG. 5 where the rotor is rotating for generating electricity in response to pressurized water from faucet impinging thereon;

FIG. 7 is a perspective view of a second preferred embodiment of mini-turbine according to the invention;

FIG. 8 is an exploded view of the mini-turbine shown in FIG. 7;

FIG. 9 is a longitudinal sectional view of the mini-turbine shown in FIG. 7;

FIG. 10 is an exploded view of a third preferred embodiment of mini-turbine according to the invention; and

FIG. 11 is a longitudinal sectional view of the mini-turbine shown in FIG. 10.

### DETAILED DESCRIPTION OF THE INVENTION

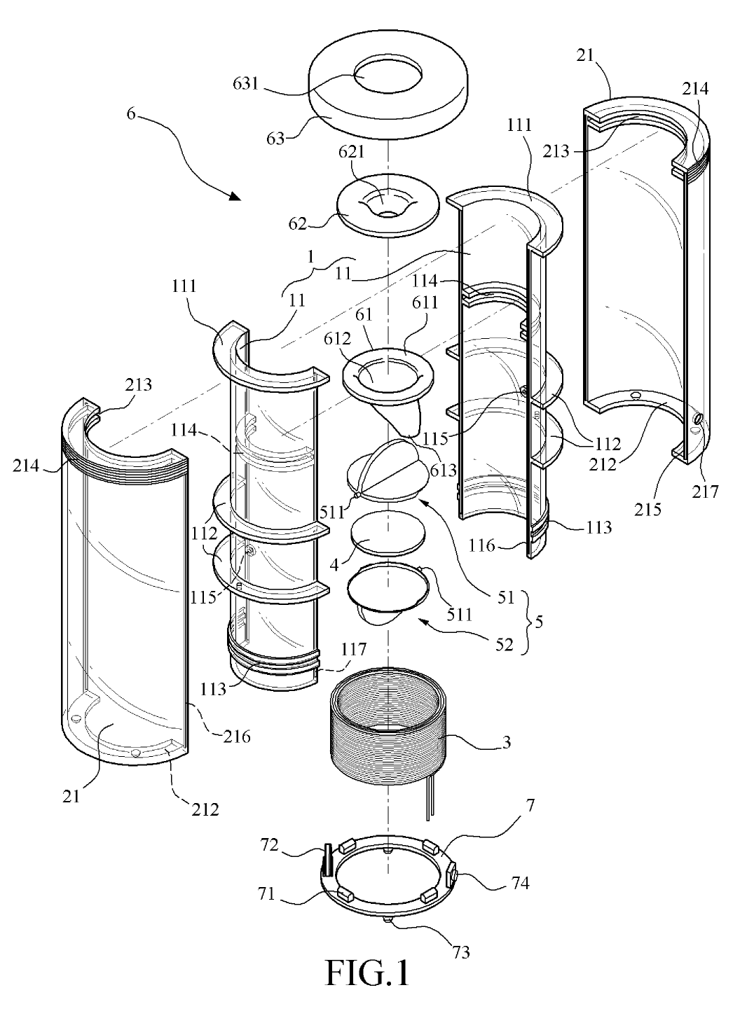

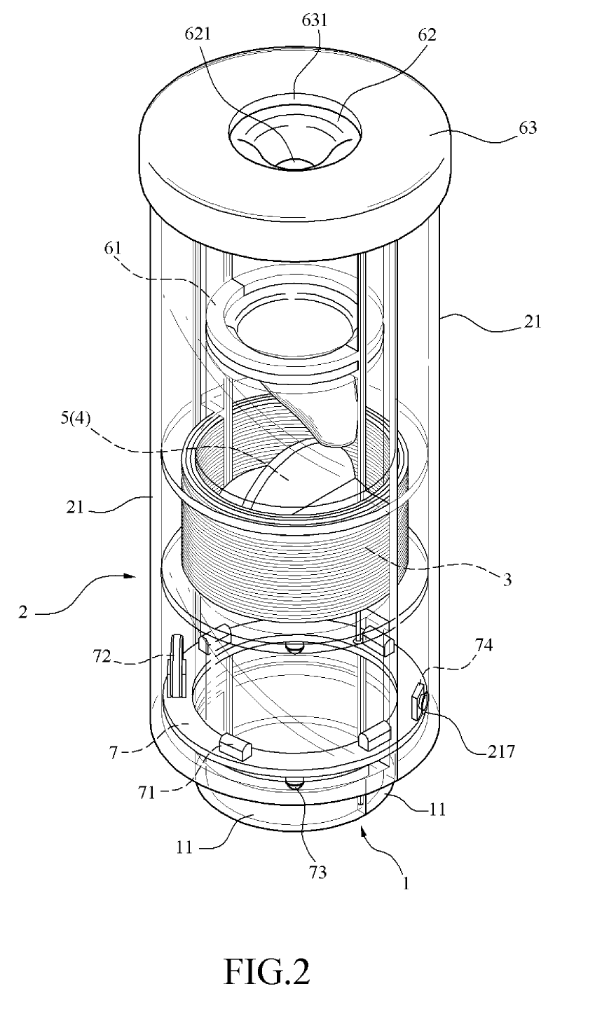

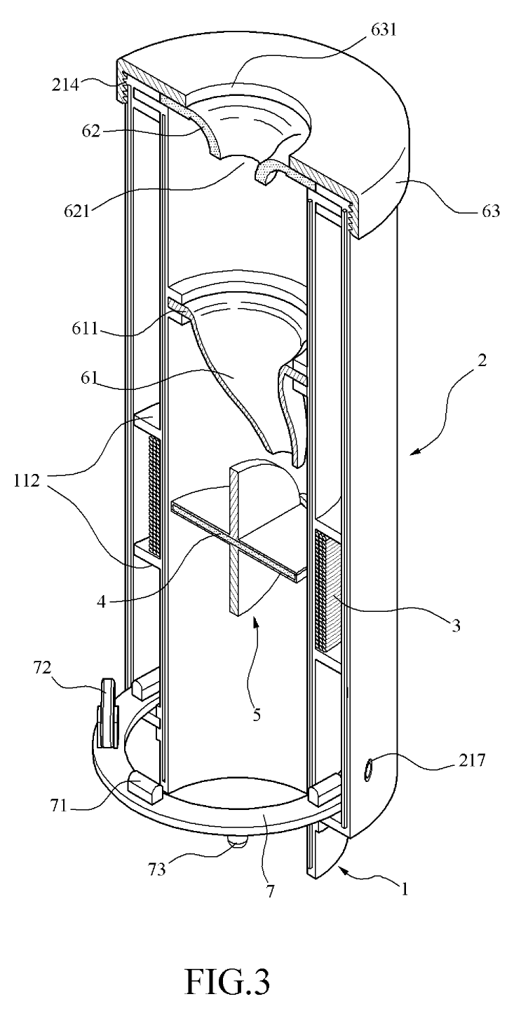

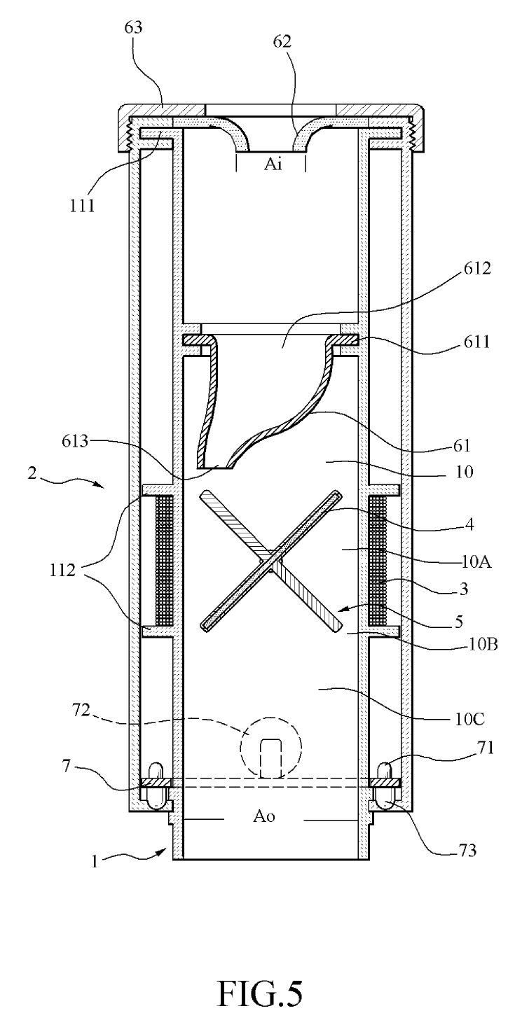

Referring to FIGS. 1 to 6, a mini-turbine in accordance with a first preferred embodiment of the invention is shown. The mini-turbine comprises the following components as discussed in detail below.

A hollow inner cylinder 1 comprises two half sections 11. The inner cylinder 1 has an annular flange 111 around a top opening (not numbered) as inlet. Either half section 11 has a lateral bossed hole 115 in an intermediate portion, an arc shaped groove 114 on an inner surface between the top opening and the hole 115, a lower arc shaped trough 113 on an outer surface, and two arc shaped flanges 112 on an outer surface in which one flange 112 is above the hole 115 and the other flange 112 is below the hole 115. Moreover, one half section 11 has two mating members 117 on both longitudinal edges and the other half section 11 has two corresponding mating members 116 on both longitudinal edges, the corresponding mating members 116 being adapted to lockingly engage with the mating members 117 to form a complete inner cylinder 1.

A hollow outer cylinder 2 comprises two half sections 21. The outer cylinder 2 has a top opening (not numbered). Either half section 21 comprises an arc shaped grooved rail 213 adjacent a top with the flange 111 fitted therein, upper arc-shaped external threads 214 having upper ends terminated at the top, and an inward extending arc shaped flange 212 on a bottom fitted in the trough 113. Moreover, one half section 21 has two mating members 216 on both longitudinal edges and the other half section 21 has two corresponding mating members 215 on both longitudinal edges, the corresponding mating members 215 being adapted to lockingly engage with the mating members 216 to form a complete outer cylinder 2. Further, the other half section 21 has a lateral aperture 217 proximate the flange 212.

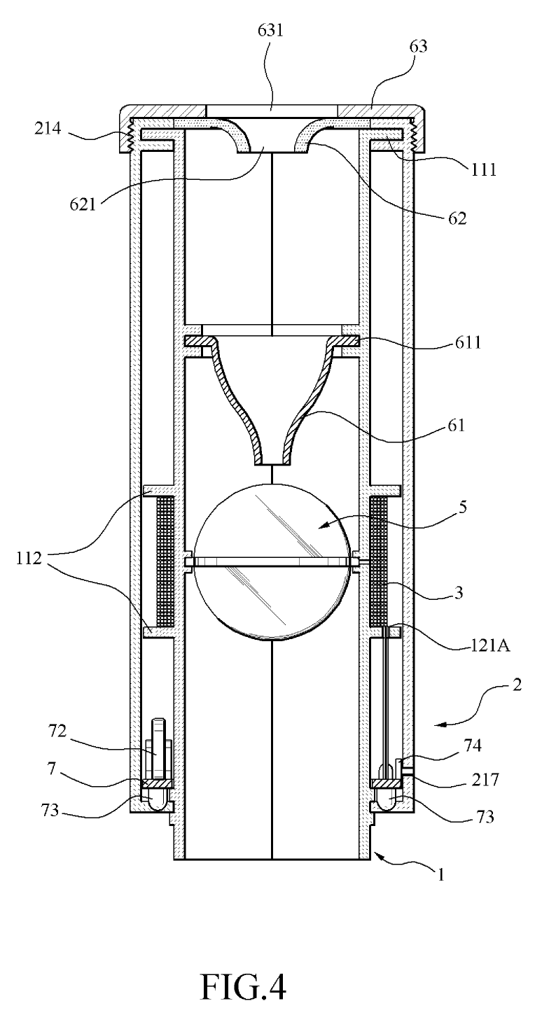

A winding 3 is wound around the inner cylinder 1 between the flanges 112. A through hole 121A is provided on a lower flange 212 of one half section 11 for permitting an inductor of the winding 3 to pass (see FIG. 4).

A rotor 5 comprises an upper blade section 51 having a pivot 511 at one side, an lower blade section 52 having a pivot 511 at the other side, and a permanent magnet 4 enclosed by the upper blade section 51 and the lower blade section 52. The pivots 511 are rotatably disposed in the holes 115. Hence, the rotor 5 may rotate about the holes 115, i.e., the inner cylinder 1.

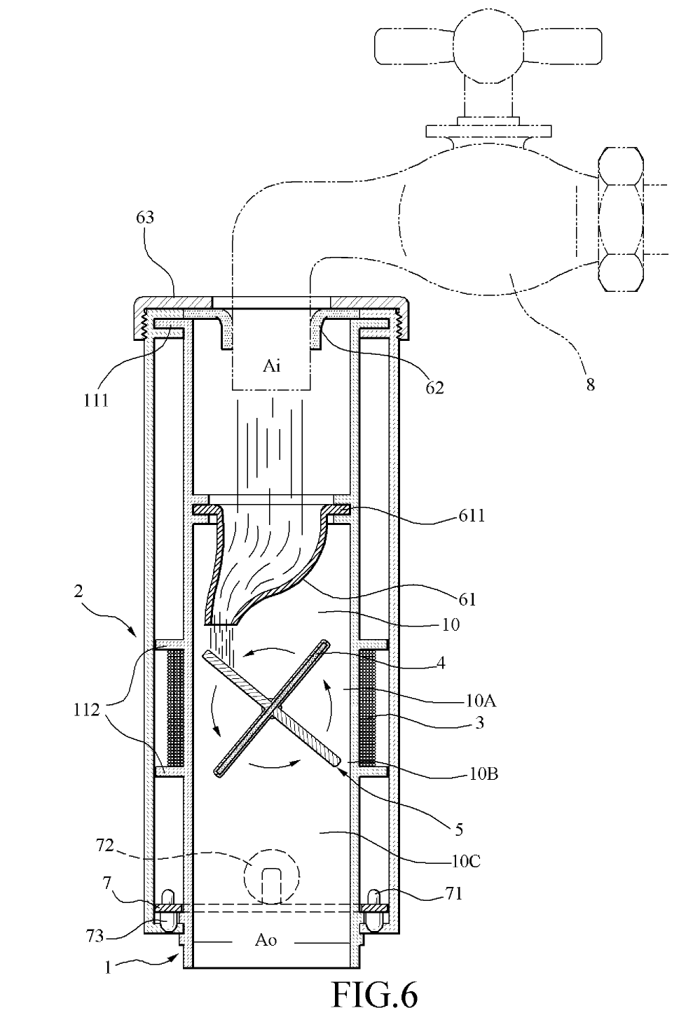

A nozzle assembly 6 comprises a spout 61 comprising an annular flange 611 fitted in the grooves 114, an inlet 612, and an outlet 613 being smaller than the inlet 612; a flexible coupling 62 seated upon the flanges 111 and having a short tubular connector 621 on a central portion, the connector 621 being adapted to secure to a faucet 8 (see FIG. 6); and a ring-shaped cover 63 comprising a central opening 631 and inner threads (not numbered) on an annular inner surface, the threads being threadedly secured to the external threads 214 to mount the cover 63 on the outer cylinder 2 and fasten the coupling 62.

A ring-shaped circuit board 7 is fitted in the troughs 113 and comprises a plurality of (four) diodes 71 equally spaced around a top surface, a rechargeable battery 72 between two adjacent diodes 71, a switch 74 projecting out of the aperture 217, the switch 74 opposite the battery 72, and a plurality of spaced LEDs (light-emitting diodes) 73 on a bottom surface. The circuit board 7 is electrically connected to the winding 3.

The operation of the mini-turbine is as follows. First, connect a faucet 8 to the connector 621. Next, open the faucet 8 to cause the pressurized water leaving the faucet 8 to impinge upon outer portions of the rotor 5 in an oblique fashion. As a result, the rotor 5 rotates about the inner cylinder 1. Lines of magnetic flux are produced by the permanent magnet 4 (i.e., there is magnetic field around the rotor 5) and they are cut by the rotating rotor 5. As a result, an induced voltage (i.e., electricity) is generated in the winding 3. The generated electricity is AC (alternating current). The AC is rectified into DC (direct current) by a full wave rectifier comprising the four diodes 71. The DC is fed to the battery 72 for storage. Moreover, a user may press the switch 217 to supply electricity from the battery 72 to the LEDs 73 for illuminating areas there below.

The permanent magnet 4 enclosed by the rotor 5 can increase weight of the rotor 5 (i.e., increased rotational inertia) so that the rotor 5 may stably rotate. Further, the permanent magnet 4 is protected from the fluid in operation. Frictional loss of the rotor 5 is reduced to a minimum. Hence, electricity generation efficiency is increased greatly. Furthermore, fluid leakage is prevented from occurring. Preferably, the rotor 5 and the permanent magnet 4 are formed integrally.

The assembly of the mini-turbine (e.g., the spout 61 and the circuit board 7) is substantially done by snapping. Hence, the assembly is quick and easy. Length of the inner cylinder 1 is longer than that of the outer cylinder 2. Hence, fluid flowing down the inner cylinder 1 is prevented from sputtering onto the flange 212. As a result, the circuit board 7 is protected.

As shown in FIG. 6, a cross section A0 of the bottom outlet of the inner cylinder 1 is greater than a cross section Ai of the coupling 62. Fluid-free space 10C below the rotor 5, fluid-free space 10 above the rotor 5, and fluid-free spaces 10A, 10B in or around the rotor 5 are formed. These spaces 10, 10A, 10B, and 10C can decrease reaction force during operation and thus increase the rotation speed of the rotor 5 (i.e., increase electricity generation efficiency).

While the fluid is described as pressurized liquid (e.g., tap water) in the first preferred embodiment of the invention, it is understood that compressed gas is equally applicable without departing from the scope of the invention.

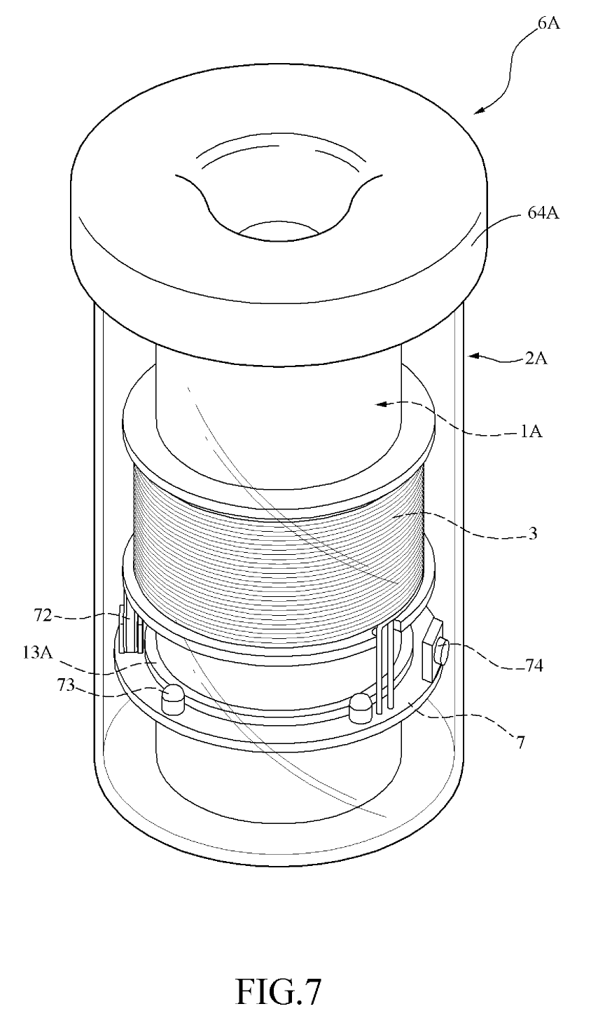

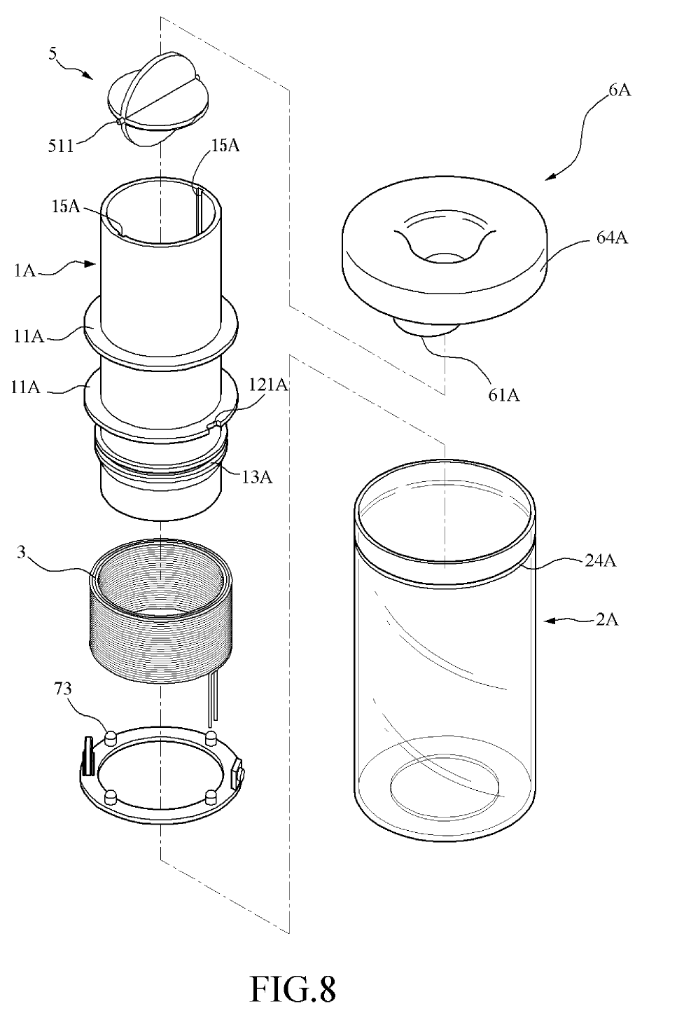

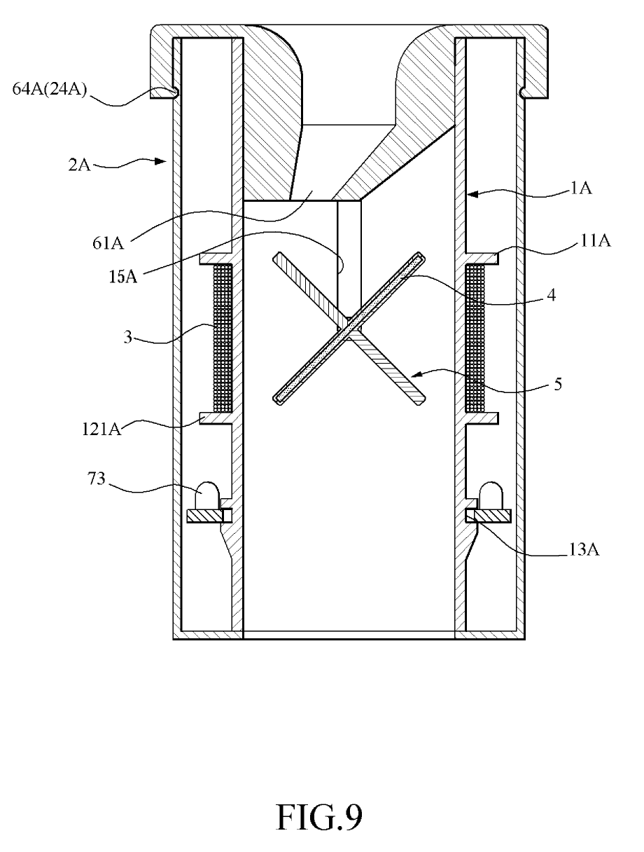

Referring to FIGS. 7 to 9, a mini-turbine in accordance with a second preferred embodiment of the invention is shown. The characteristics of the second preferred embodiment are detailed below. An inner cylinder 1A is an integral member. An outer cylinder 2A is an integral member. A nozzle assembly 6A is an integral member and has the functions of both as a cover and a nozzle. Two opposed grooved rails 15A are formed on an upper portion of an inner surface of the inner cylinder 1A. Pivots 511 may fit in the grooved rails 15A. A recess 121A is provided on a lower annular flange 11A for permitting an inductor of the winding 3 to pass. A lower annular trough 13A is provided on a lower portion of an outer surface of the inner cylinder 1A for permitting the circuit board 7 to mount thereon. An annular recess 24A is formed on an upper portion of an outer surface of the outer cylinder 2A. The nozzle assembly 6A comprises a downward extending annular flange 64A adapted to matingly fit onto the recess 24A to form a smooth outer surface of the outer cylinder 2A. Also, the spout 61A is disposed in an upper portion of the inner cylinder 1A.

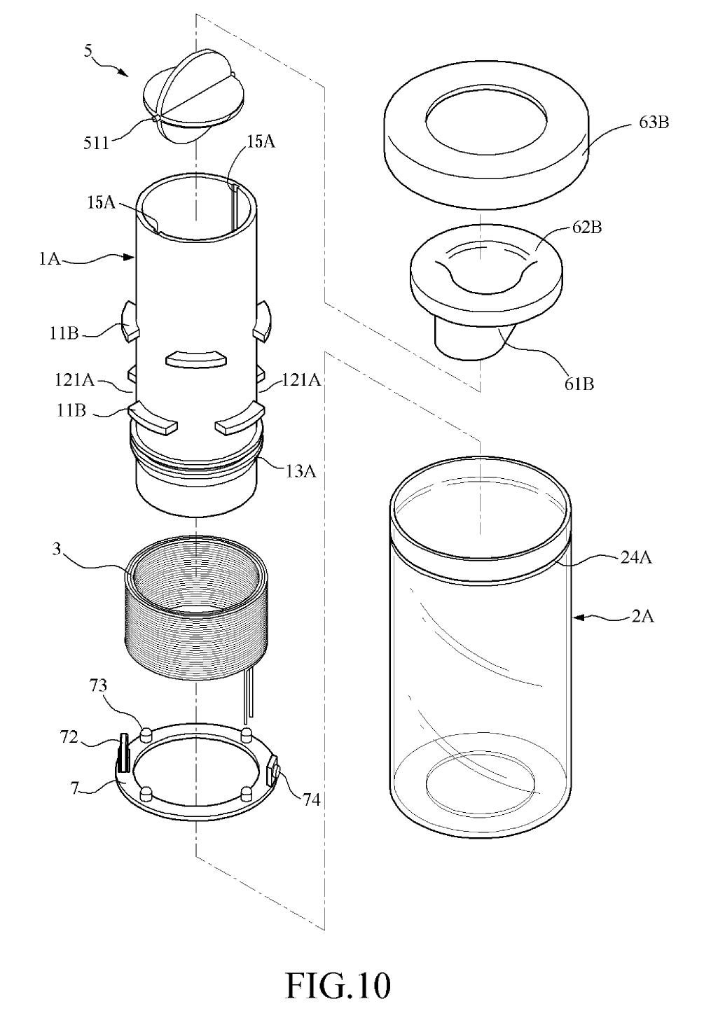

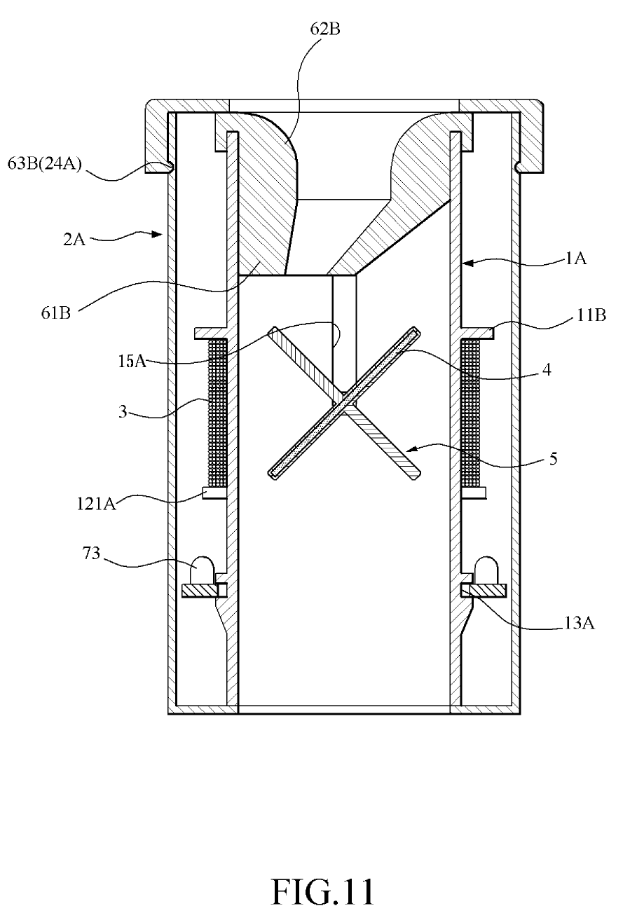

Referring to FIGS. 10 and 11, a mini-turbine in accordance with a third preferred embodiment of the invention is shown. The third embodiment is identical to the second embodiment, except that the spout 61B and the flexible coupling 62B are formed of the same flexible plastic material. The cover 63B is formed of hard plastic material and is produced separately from both the spout 61B and the flexible coupling 62B. Two rows of four equally spaced apart short ribs 11B are provided on an outer surface of the inner cylinder 1A. The winding 3 is mounted between the two rows of four equally spaced apart short ribs 11B. Two opposite notches 121A each between two adjacent ribs 11B is adapted to permit an inductor of the winding 3 to pass to electrically connect to the circuit board 7.

While the above embodiment discussing an application of the mini-turbine for generating electricity to illuminate LEDs, it is apparent that electricity generated by the mini-turbine may be supplied to a charger, a radio, or low power appliances in other embodiments.

While the invention herein disclosed has been described by means of specific embodiments, numerous modifications and variations could be made thereto by those skilled in the art without departing from the scope and spirit of the invention set forth in the claims.

What is claimed is:

1. A mini-turbine comprising:
a hollow inner cylinder adapted to connect to a fluid source;
a rotor disposed in and rotatably connected to the inner cylinder, the rotor comprising a plurality of blades and an enclosed permanent magnet for producing a magnetic field;
a winding mounted around an outer surface of the inner cylinder and being about flush with the rotor;
a hollow outer cylinder mounted around the inner cylinder in a spaced fashion; and
a nozzle assembly disposed at a top opening of the inner cylinder and extending to a predetermined position above the rotor,
wherein pressurized fluid from the fluid source may impinge upon the blades to rotate the rotor after passing the nozzle assembly so that the rotor may cut lines of magnetic flux in the magnetic field to generate an induced AC (alternating current) voltage in the winding.

2. The mini-turbine of claim 1, wherein the number of the blades is four, and wherein the permanent magnet is disposed within a first one of the blades and a third one of blades being opposite the first blade by snapping.

3. The mini-turbine of claim 1, wherein the rotor and the permanent magnet are formed integrally.

4. The mini-turbine of claim 1, further comprising a ring-shaped circuit board disposed between lower portions of the inner and outer cylinders, the circuit board being electrically connected to the winding thereabove and comprising a full wave rectifier for converting the AC voltage into a DC (direct current) voltage.

5. The mini-turbine of claim 4, wherein the circuit board further comprises a rechargeable battery adapted to be charged by the full wave rectifier.

6. The mini-turbine of claim 4, wherein the circuit board further comprises a plurality of light sources.

7. The mini-turbine of claim 6, wherein the light sources are a plurality of LEDs (light-emitting diodes).

8. The mini-turbine of claim 6, wherein the circuit board further comprises a switch mounted on the outer cylinder, the switch being adapted to manually press to be either on to electrically connect the full wave rectifier to the light sources or off.

9. The mini-turbine of claim 1, wherein the outer cylinder comprises an upper annular groove, and wherein the inner cylinder comprises an annular flange member around the top opening thereof, the flange member being fitted in the groove by snapping to assemble the inner and outer cylinders together.

10. The mini-turbine of claim 1, wherein the nozzle assembly comprises a ring-shaped cover releasably mounted on the outer cylinder, an oblique spout disposed at the predetermined position above the rotor, and a flexible coupling fastened between the cover and the spout, the coupling being adapted to secure to the fluid source.

11. The mini-turbine of claim 1, wherein the inner cylinder comprises intermediate annular first and second flanges on an outer surface thereof, and wherein the winding is fastened between the first and second flanges.

12. The mini-turbine of claim 1, wherein the inner cylinder comprises two half sections.

13. The mini-turbine of claim 1, wherein the outer cylinder comprises two half sections.

14. The mini-turbine of claim 1, wherein the inner cylinder comprises a bottom outlet having a cross section larger than that of the spout.

15. The mini-turbine of claim 1, wherein the inner cylinder is formed integrally.

16. The mini-turbine of claim 1, wherein the outer cylinder is formed integrally.

17. The mini-turbine of claim 10, wherein the ring, the coupling, and the spout of the nozzle assembly are formed integrally.

18. The mini-turbine of claim 10, wherein the coupling and the spout of the nozzle assembly are formed integrally, and the ring and the coupling are produced separately.

19. The mini-turbine of claim 1, wherein the pressurized fluid is liquid.

20. The mini-turbine of claim 1, wherein the pressurized fluid is gas.
